(19) United States
(12) Patent Application Publication
(10) Pub. No.: US 2010/0129783 A1
(43) Pub. Date: May 27, 2010

(54) Self-Adaptive Study Evaluation

(76) Inventors: Changnian Liang, Shanghai (CN); Pingyi Yan, ShenZhen (CN); Xiaofeng Zhang, Hangzhou (CN); Yuan Li, ShenZhen (CN)

Correspondence Address: LEE & HAYES, PLLC, 601 W. RIVERSIDE AVENUE, SUITE 1400, SPOKANE, WA, 99201, US

(21) Appl. No.: 12/323,331

(22) Filed: Nov. 25, 2008

(51) Int. Cl. G09B 5/00

(52) U.S. Cl. 434/322

(57) ABSTRACT

A study evaluation system used for computer-based learning uses evaluation contents arranged in a multilevel arrangement for self-adaptive study evaluation. The study evaluation system provides a present evaluation content to a user through user interaction, and determines a subsequent evaluation content or a subsequent knowledge point to be studied by the user at least partially based on the user feedback on the present evaluation content, the multilevel arrangement of the evaluation contents, and a characteristic information of the user. The study evaluation system may further establish a data set for each user to record the user feedbacks on the evaluation contents, and use the data set in combination with certain basic user information to realize individualized study evaluation.

### RELATED APPLICATIONS

This application is related to U.S. patent application Ser. No. 12/121, 249, filed on May 15, 2008, entitled “DIFFERENTIATED, INTEGRATED AND INDIVIDUALIZED EDUCATION”; and U.S. patent application Ser. No. 12/168, 777, filed on Jul. 7, 2008, entitled “USER INTERFACE FOR INDIVIDUALIZED EDUCATION”, which US patent applications are hereby incorporated by reference in their entirety.

### BACKGROUND

This disclosure relates to the field of computer-based education and learning systems, and particularly to Internet-based education and learning systems.

As Internet becomes widely popular, a number of Internet-based education websites, including some evaluation and testing websites, have begun to emerge. However, these existing evaluation websites simply post test questions on the Internet without tailoring to the needs of individual users. Some professional exam websites provide materials mainly for passing a proficiency test or an accreditation test but not for testing the progressive academic level of a student and determining what a next topic the student should learn. These websites therefore do not provide better targeted instruction and training for the student's learning. Evaluation contents of existing evaluation websites are also not systematically organized, and are usually made up of collections of exercises or simple combinations of exam questions accumulated from the past. These evaluation contents fall short of systematically representing the characteristics of knowledge contents and are not constructed and organized with a careful arrangement that is suited for computer-based education applications. As a result, a user has to repeatedly practice a number of exercises and exam questions of the same types. Even after the student (user) completes lots of the exercises and the exam questions, the weak points of the student are usually not clearly identified and made transparent to the student himself, much less to the instructors and parents. As a result, the existing evaluation websites tend to waste a great deal of the time and energy of the student and lead to tiredness and boredom. Such teaching systems may have a negative impact on the self-esteem or even the mental health of a student, especially at early learning stage of the student.

The utilization of Internet in the existing Internet-based evaluation websites is limited to the convenience of access only, and is not for taking advantage of the rapidly developing computer systems and Internet technologies. These websites do not take advantage of the dynamic nature of an Internet-based computer system, nor the collective intelligence and automatic self-learning power of an Internet-based computer system. This results in a disconnection of the evaluation process and the ability of a student from the evaluation contents provided by the evaluation system. For example, an evaluation process of a student in the existing evaluation websites is normally not recorded. As such, the student cannot lookup his/her past evaluation records, and the evaluation system cannot analyze the past evaluation records of the student to better diagnose the degree of the student's understanding of a knowledge point which is being assessed by the evaluation content, and hence may not provide the right kind of evaluation contents that are suited for the user. In addition, due to a lack of the evaluation process record, the existing evaluation websites are incapable to identify the weak points of a student on a knowledge point, and thus fail to provide effective tutoring that focuses on the weak points that should draw the student's special attention during study or review.

In summary, the existing evaluation systems fall far short of achieving true individualized study evaluation. These systems are limited by fixed topics, generic standard answers, inflexible communication and mechanical representations. There usually exists a large discrepancy between the actual evaluation efficiency and the aimed evaluation efficiency. This not only wastes resources but also discourages students from practicing exercises, tests and evaluation questions.

### SUMMARY

This disclosure describes a study evaluation system for providing self-adaptive evaluation or individualized evaluation of a user's study. The system provides evaluation contents systematically organized using a multilevel arrangement according to various attributes of the evaluation contents, including the structure of the underlying knowledge points being evaluated. The evaluation system aims to solve the shortcomings of existing Internet-based evaluation systems. Upon analyzing a feedback on the evaluation content from the user, the evaluation system provides a subsequent evaluation content or a subsequent knowledge point that the user needs to learn. The evaluation system interacts with the user and provides optimal relevant evaluation content to the user to be studied at each stage.

According to one aspect of this disclosure, a study evaluation method using a computer-based study evaluation system is disclosed. The study evaluation system contains evaluation contents and their solution contents. Each evaluation content is used to assess one or more knowledge points. The evaluation contents are systematically organized using a multilevel arrangement. The method uses a study evaluation system to provide a present evaluation content to a user through user interaction and to receive a feedback of the user with respect to the present evaluation content. The evaluation system analyzes the feedback of the user on the present evaluation content based on the solution contents to obtain an analysis result, and determines a subsequent evaluation content or a subsequent knowledge point to be studied by the user. The determination is made at least partially based on a variety of information including the analysis result, the multilevel arrangement and a characteristic information of the user.

Preferably, the evaluation system assigns a user ID for each user, and creates or updates a data set related to the user ID for each user. The data set includes feedbacks of the user on one or more evaluation contents and/or the system analysis results of the feedbacks. The recorded feedbacks and the analysis results constitute historic information of the user, which becomes a part of the characteristic information of the user. The evaluation system determines the subsequent evaluation content or the subsequent knowledge point for future study further based on the recorded feedbacks and analysis results stored in the data set.

The characteristic information of a user may further include basic information such as personal and background information of the user. The evaluation system may also determine the subsequent evaluation content or the subsequent knowledge point suited for the user based further on the basic information of the user.

In one embodiment, the evaluation system also considers the recorded feedbacks of one or more other users with respect to the evaluation contents to determine the subsequent evaluation content or the subsequent knowledge point for the present user.

In some embodiments, the evaluation contents in the evaluation system are arranged in a multilevel arrangement at least partially based on a multilevel arrangement of the knowledge points that are assessed by the evaluation contents. Both the multilevel arrangement of the evaluation contents and the multilevel arrangement of the knowledge points may have a hierarchical structure. For example, an evaluation content used for assessing a higher level knowledge point is a higher level evaluation content, while an evaluation content used for assessing one or more lower level knowledge points of the higher level knowledge point is a lower level evaluation content relative to the higher level evaluation content.

Another aspect of the present disclosure is a study evaluation system performing self-adaptive evaluation of a user. The evaluation system contains pre-stored evaluation contents and their solution contents. Each evaluation content is used for assessing one or more knowledge points. The evaluation contents are arranged in a multilevel arrangement. The study evaluation system includes an user interaction unit used for providing a present evaluation content to a user and receiving a feedback of the user with respect to the present evaluation content. The evaluation system further includes an analyzing unit used for analyzing the feedback of the user on the present evaluation content according to the pre-stored solution contents to obtain an analysis result. A determining unit is used for determining a subsequent evaluation content or a subsequent knowledge point to be studied by the user, based on the analysis result, the multilevel arrangement and characteristic information of the user.

The disclosed method and system are capable of achieving self-adaptive and individualized study evaluation of a user's study. This is done in some embodiments by systematically organizing the evaluation contents into a multilevel arrangement, using individualized basic information of the users, and recording or storing information of study history of each user such as feedbacks of the users on the evaluation contents. The evaluation of a user with respect to a certain evaluation content or knowledge point may be assisted not only by the same user's past records but also other users' past records with respect to the same or other evaluation contents or knowledge points. Fast and accurate diagnosis of the user's understanding of a certain knowledge point is made possible.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE FIGURES

The detailed description is provided below with reference to the accompanying figures.

FIG. 1 shows a structural diagram of an exemplary study evaluation system used in a computer-based learning system in accordance with the present disclosure.

FIG. 2 shows a flow chart of an exemplary process of study evaluation.

FIG. 3 shows an exemplary tree structure of knowledge points in Elementary Mathematics in accordance with the present disclosure.

FIG. 4 shows an exemplary web interface of the evaluation system in accordance with the present disclosure.

FIG. 5 shows a schematic structural diagram of an exemplary embodiment of the study evaluation system.

### DETAILED DESCRIPTION

Prior to describing the exemplary embodiments of the present study evaluation system and method, this disclosure first explains some of the technical terms used herein.

Knowledge point: a knowledge point is a cognitive element of a body of knowledge, such as a branch of science, a combination of several related sciences, an educational course, or any subject of learning. According to the laws of human cognition and specific applications of the knowledge, knowledge of a subject is differentiated into multiple knowledge points. Such differentiation is usually multilayered and may reach the most elemental knowledge points, beyond which further differentiation is no longer practical or helpful for the learning purpose. For instance, arithmetic, a subject of entry-level Mathematics, can be differentiated into multiple first level knowledge points such as “Numbers”, “Calculations”, “Measures”, “Applications” (or “Word Problems”), “Shapes”, “Algebra”, and “Statistics”. The first level knowledge point “Numbers” can be further differentiated into several second level knowledge points such as “Concept of Numbers”, “Integers”, “Decimals”, “Fractions”, “Divisions”, “Fraction and Percentage” and “Ratio and Proportion”. By the same token, each second level knowledge point may be further differentiated into multiple third level knowledge points.

Multilevel arrangement of knowledge points: a multilevel arrangement of knowledge points is a multilevel arrangement of multiple knowledge points of a certain subject, a combination of related subjects or a certain curriculum. The knowledge points are organized according to the degrees of advancement and complexity of the knowledge points and/or inter-relations among them. A multilevel arrangement of knowledge points may include one or a combination of various types of topologies such as a tree structure, a pyramidal structure, a star structure, a chain structure, a ring structure and a grid structure. The multilevel arrangement includes information describing the inter-relations among knowledge points and indicative information of related knowledge points of each knowledge point. The information describing the inter-relations may include information indicating preparatory knowledge point(s) of each knowledge point.

Evaluation content: an evaluation content may refer to a material used for various purposes including evaluation, diagnosis and practices, and may be classified into various types such as exercises, quiz questions and comprehensive evaluation questions according to the purpose of the use. An evaluation content may include one or more exercises, quiz questions, comprehensive evaluation questions, or a combination thereof. Evaluation contents in this disclosure may be carefully selected and arranged in order to efficiently help users to learn the knowledge content by maximizing study efficiency and avoiding burying students with an excessive number of tests and problems. In this disclosure, “user” and “student” are used interchangeably unless indicated otherwise in a specific context.

Solution content: a solution content contains answers to one or more evaluation contents, and may include the final answers to the questions in the evaluation content and may also include the work processes that lead to the correct answers. One example is a geometric proof. If multiple solutions for a question exist, the answer to the evaluation content may include multiple answering processes. An evaluation content and a solution content may be embodied in various forms including text, graphics and images (static or animated), audio, video and multimedia.

Multilevel arrangement of evaluation contents: a multilevel arrangement of evaluation contents is a relation-based arrangement of multiple evaluation contents of a certain subject, a combination of related subjects or a certain curriculum. The multilevel arrangement of evaluation contents is not the same as the multilevel arrangement of knowledge points, but the two arrangements may be related to each other as described herein. The evaluation contents may be organized according to such criteria as the types and difficulty levels of the evaluation contents and features (e.g., difficulty level) of knowledge points being evaluated. For example, for a given knowledge point, the associated evaluation contents may be any of multiple types including basic concepts, calculations, applications, and comprehensive questions, and the evaluation contents of each type may further have multiple difficulty levels. A multilevel arrangement of evaluation contents may include one or a combination of various types of topologies such as a tree structure, a pyramidal structure, a star structure, a chain structure, a ring structure and a grid structure. Each of these topologies may represent at least connection relationships between evaluation contents by having a connection line between two related evaluation contents, but may also represent hierarchical relationships by the relative positions of the evaluation contents in the topology.

In one embodiment, the evaluation contents are arranged in a preset structure based on the information of the knowledge points assessed by the evaluation contents. For example, the evaluation contents may be arranged in a preset structure based upon a multilevel arrangement of the knowledge points assessed by the evaluation contents. In this embodiment, the multilevel arrangement of the evaluation contents is, or has a subset arrangement which is, a superposition of the multilevel arrangement of the knowledge points. However, the multilevel arrangement of the evaluation contents and the corresponding multilevel arrangement of the knowledge points are usually not identical because each evaluation content may be related to multiple knowledge points and vice versa, and further among the evaluation contents related to a certain knowledge point, different difficulty levels may be assigned to different evaluation contents. Preferably, evaluation contents corresponding to each knowledge point may be divided into different levels according to the degree of difficulties of the evaluation contents. Each level may include one or more evaluation contents of about the same degree of difficulty.

Preferably, the multilevel arrangement of evaluation contents may have a hierarchical structure having evaluation contents of a higher level arranged above evaluation contents of a relatively lower level. In a hierarchical structure, the levels may be defined in various ways with consideration of various characteristics of the evaluation contents, either individually or in combination. For example, levels may be defined according to the levels of the associated knowledge points. Specifically, an evaluation content used for evaluating one or more higher level knowledge points is a higher level evaluation content relative to an evaluation content used for evaluating one or more lower level knowledge points, and vice versa. For another example, levels may be defined according to the difficulty levels of the evaluation contents. Specifically, an evaluation content that is more difficult (or has a higher difficulty level) is a higher level evaluation content relative to an evaluation content that is less difficult, and vice versa. For yet another example, levels may be defined according to comprehensiveness levels of evaluation contents. Specifically, an evaluation content which is used for evaluating a group of knowledge points is a higher level evaluation content relative to an evaluation content that is used for evaluating a subgroup of knowledge points in the group of knowledge points.

Study evaluation system: a study evaluation system is a part of a computer-based learning system, used for evaluating or diagnosing the study of a user. In this disclosure, “study evaluation system” and “evaluation system” are used interchangeably. A study evaluation system has stored therein evaluation contents and their solution contents. Each evaluation content is used for assessing or evaluating one or more associated knowledge points. The evaluation system may include evaluation contents of one or more subjects or curricula. The evaluation contents of each subject or curriculum are organized according to a respective multilevel arrangement separately. The evaluation system can provide an evaluation content to a user after the user accesses the evaluation system through a user terminal, and receive a feedback from the user on the evaluation content. Based on the answers in the solution contents, the evaluation system analyzes the feedback of the user to obtain an analysis result, and determines a subsequent evaluation content or a subsequent knowledge point for the user. The determination is done by considering the analysis result and other information such as the multilevel arrangement of the evaluation content and characteristic information of the user.

In one embodiment, the evaluation system may store relational information which characterizes the evaluation contents and describes the relations among the evaluation contents. The relational information may include information of a knowledge point assessed by the evaluation content, level (i.e., grade) of the knowledge point being assessed, and type of the evaluation content. In one embodiment, the relational information associated with each evaluation content may include the respective values of a set of attributes that are used to characterize the evaluation content. Examples of such attributes include at “subject matter”, “grade level”, “related knowledge point(s)”, “evaluation type”, “difficulty level”, and “comprehensiveness level” etc. Each evaluation content's values of the set of attributes may be stored as a multi-field record of a database in which each attribute corresponds to a field of the record.

An evaluation system may be implemented on a website (hosted on a network server, for example) which can be accessed from a user terminal, such as a personal computer. Alternatively, the evaluation system may be stored in the user terminal, and optionally updated periodically from a server through the Internet. The functions of an evaluation system can be implemented by software, hardware or a combination thereof.

Characteristic information of a user (user characteristic information): in this disclosure, characteristic information of a user refers to information that tends to distinguish the user from other users. Such characteristic information may include basic personal information which is relatively static and more dynamic individualized information such as history information of the user using the evaluation system. The history information may include past track information of knowledge points and evaluation contents provided to or selected by the user, the prior feedbacks provided by the user on the evaluation contents, the analysis results by the evaluation system analyzing the prior feedbacks of the user, such as percentage scores (correct rates) and the feedback speed of the user, etc. In one embodiment, the subsequent evaluation content is determined by the evaluation system at least partially based on the characteristic information of the user.

In this disclosure, the characteristic information of the user is dynamic and changes as the user interactively use the computer-based study evaluation system. For example, in the present disclosure, the current user feedback to the present evaluation content is not yet considered a part of the characteristic information of the user at the time when the user has just finished the present evaluation content and when the evaluation system is determining the subsequent evaluation content (although the evaluation system may nonetheless consider the user's current feedback to the present evaluation content as a present user input when determining the subsequent evaluation content of the same user). However, at the time when the user has further finished the subsequent evaluation content provided and when the evaluation system is determining the next subsequent evaluation content, the user feedback to the previous evaluation content may have been stored in a user data set and become a part of the characteristic information of the user.

Once it becomes a part of the characteristic information of a user, the information may influence the evaluation system's selection of a study course of not only the present user but also other users. Such track information is a dynamic characteristic of the user which influences what future evaluation contents and knowledge points the study evaluation system will provide to the user to learn. In other words, while the user learns the subject using the study evaluation system, the study evaluation system is also learning about the user, resulting in a self-adaptive study evaluation system and learning system.

Basic information of a user: basic information of a user is a type of characteristic information of the user. Examples of basic information of a user include background information and personal information such as the gender, age, and grade level of the user, school(s) where the user is attending or has attended, geographic location(s) of the user's past and current residence; education level of the user's guardian, occupation of the user's guardian, and favorite study subject(s) of the user, etc. The basic information of a user may be entered by the user when the user starts to use the study evaluation system. Such information is relatively static. Nevertheless, the user information may become a part of the user profile which may be updated any time by the user.

Analysis result: an analysis result refers to a result obtained by the evaluation system upon analyzing a feedback of a user on an evaluation content. The analysis is usually done using related solution contents as references. In this disclosure, “analysis result” and “study result” are used interchangeably unless indicated otherwise in a particular context. There is no restriction on the manner by which an analysis result is embodied or manifested. An analysis result may be a simple analysis result of the accuracy of feedbacks of a user. In cases where an evaluation content has multiple questions, the analysis result may be a percentage score calculated based on correct answers. If different scores are assigned individually to each question, the analysis result may be the final score obtained. An analysis result may also be manifested as a grade mark (such as unsatisfactory, satisfactory, good and excellent).

The analysis results of the user may become the historical information of the user which constitutes part of the characteristic information of the user. The analysis results may not only include those obtained in immediate response to a feedback of the user, but also those obtained at any other time as needed. For example, as a user progresses in the study, the evaluation system may periodically perform comprehensive analysis of the study results of the user and store the analysis results as part of the characteristic information of the user into a data set associated with the user. The data set may be manifested as a learning profile of the user which can be dynamically updated as the user progresses in the study.

In a more sophisticated case, an analysis result may be a result of diagnosing a student's weak points, strong points, areas that are surpassing requirements, areas that need improvement, areas that indicating misunderstanding or lack of understanding, etc., with respect to a subject matter and/or a knowledge point.

### Exemplary Implementation Environment

Prior to describing exemplary embodiments of the method and system of the present disclosure, an exemplary implementation environment is described to provide an overview of the method and system and their implementation and application environment. It is noted that the disclosed method and system can be implemented using either software or hardware only, but preferably should be implemented using a combination of software and hardware. The disclosed method itself can be implemented in the form of software products stored in a storage media. The software includes instructions for a computer device (either stand-alone or networked) to execute the method described in the exemplary embodiments of the current disclosure.

In particular, the above-described techniques may be implemented with the help of a computing device, such as a server or a personal computer (PC) having a computing unit, as illustrated below.

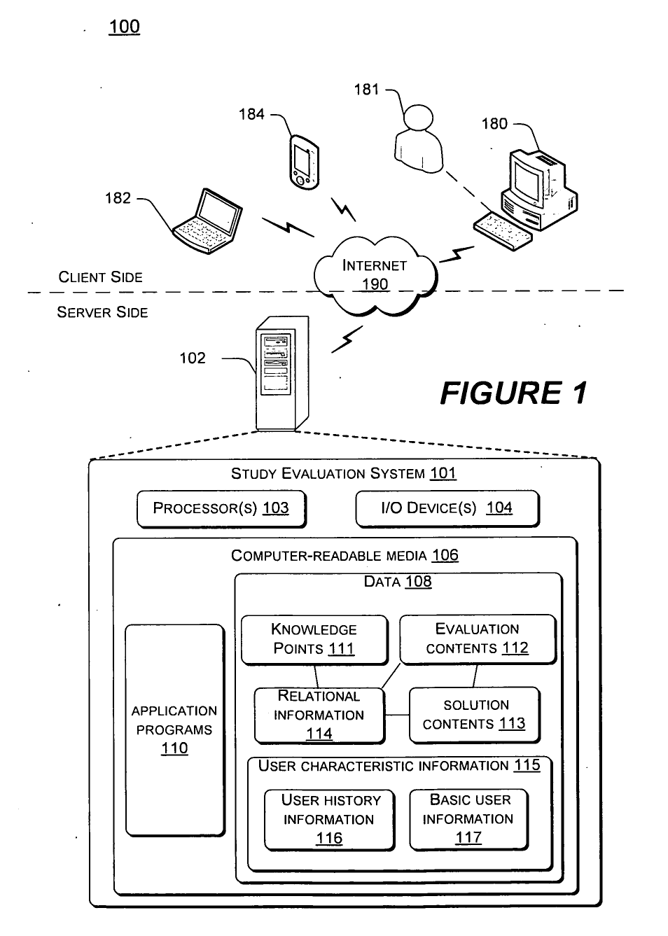

FIG. 1 shows an exemplary environment for implementing the method of the present disclosure. In illustrated environment 100, some components reside on a client side and other components reside on a server side. However, these components may reside in multiple other locations. Furthermore, two or more of the illustrated components may combine to form a single component at a single location.

A study evaluation system 101 is implemented with a computing device 102 which includes processor(s) 103, I/O devices 104, computer readable media 106, and network interface (not shown). The server 102 is connected to client-side computing devices (user terminals) such as 180, 182 and 184 through network(s) 190. In one embodiment, computing device 102 used for implementing the study evaluation system 101 is a server, while client-side computing devices 180, 182 and 184 may each be a computer or a portable device, such as a PC, a user terminal or a cell phone.

The computer readable media 106 stores data 108 and application program modules 110. The data 108 may include information of knowledge points 111, evaluation contents 112, solution contents 113, relational information 114, and user characteristic information 115. The user characteristic information 115 includes user history information 116 and basic user information 117. The application program modules 110 contain instructions which, when executed by processor(s) 103, cause the processor(s) 103 to perform actions of a process described herein.

The data 108, including the information of knowledge points 111, evaluation contents 112, solution contents 113, relational information 114, and user characteristic information 115, may at least partially be stored in one or more databases. In one embodiment, the relational information 114 contains information defining the relations among the knowledge points 111, the evaluation contents 112 and the solution contents 113. Such relations form a basis for the definitions of the multilevel arrangements of the knowledge points 111 and the evaluation contents 112. For example, each evaluation content may be characterized by its respective values of a set of attributes including at least one of “subject matter”, “grade level”, “related knowledge point(s)”, “evaluation type”, “difficulty level”, and “comprehensiveness level”. Each evaluation content's respective values of the set of attributes may be specified in the corresponding relational information 114 and stored as a multi-field record of a database in which each attribute corresponds to a field of the record. Various types of databases may be used for this purpose, including relational database, hierarchical database, object-oriented database, and hypertext database.

It is appreciated that the computer readable media may be any of the suitable storage or memory devices for storing computer data. Such storage or memory devices include, but not limited to, hard disks, flash memory devices, optical data storages, and floppy disks. Furthermore, the computer readable media containing the computer-executable instructions may consist of component(s) in a local system or components distributed over a network of multiple remote systems. The data of the computer-executable instructions may either be delivered in a tangible physical memory device or transmitted electronically.

It is also appreciated that a computing device may be any device that has a processor, an I/O device and a memory (either an internal memory or an external memory), and is not limited to a personal computer. Especially, computer device 102 used for implementing the study evaluation system 101 may be a server computer, or a cluster of such server computers, connected through network(s) 190, which may either be Internet or an intranet.

A client computing device is not limited to a personal computer, a cell phone, or PDA, but also includes any kind of an electronic device suited as a user device for accessing the network server 102. The communication between a user 181 and the network server 102 can be, but not limited to a logon method. The user 181 may use text messaging of a cell phone to communicate with the network server 102. For instance, user 181 can send a numerical command to “XYZ” website hosting the study evaluation system 101, to indicate a request for an evaluation content corresponding to a knowledge point “Word Problems for Addition”. Upon receiving such a request, the network server 102 provides the requested content to the user.

In one exemplary application, the user 181 logs onto the evaluation system 101 provided by the network server by entering a username and a correct password, interacts with the evaluation system by selecting an evaluation content of interest for a study or evaluation purpose, and provides a feedback with respect to the evaluation content back to the evaluation system 101. The evaluation system 101 determines a subsequent evaluation content for the user 181 based upon the feedback given by the user 181, and other information as described herein.

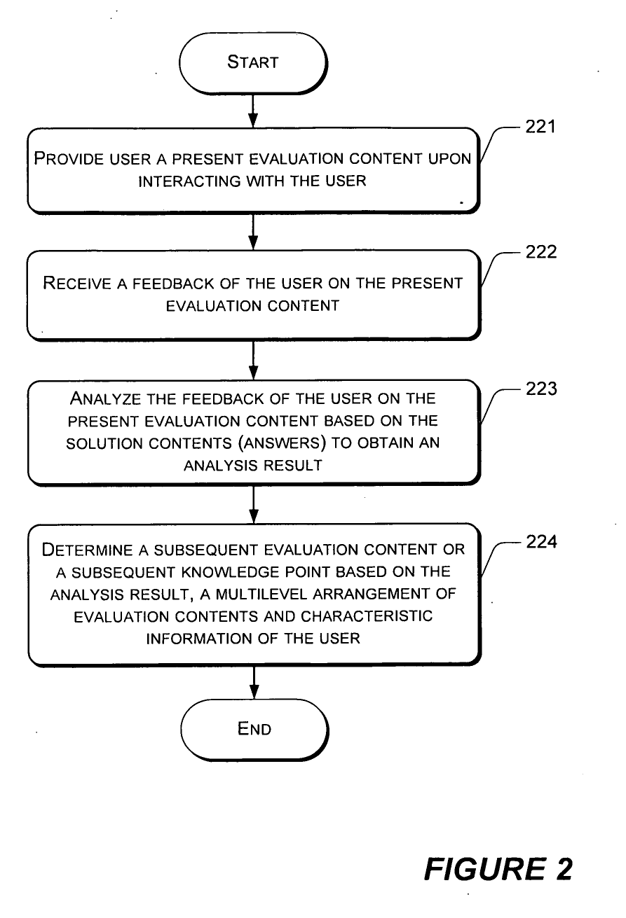

FIG. 2 is a flow chart of an exemplary evaluation process. The flowchart of FIG. 2 is described in further detail with reference to FIG. 1. In this description, the order in which a process is described is not intended to be construed as a limitation, and any number of the described process blocks may be combined in any order to implement the method, or an alternate method.

At block 221, an evaluation system interacts with a user 181 and provides a present evaluation content for the user. As shown in FIG. 1, the evaluation system 101 implemented by the network server 102 interacts with the user 181 through a client computing device (180, 182 or 184). For example, a user 181 may use a Web browser to access an evaluation system 101's website. The present evaluation content is selected from evaluation contents 112. The present evaluation content may be either selected by the user or automatically provided by the evaluation system 101. The present evaluation content may also be provided in a combination of both a manual selection and automatic selection. For example, the evaluation system 101 may automatically narrow down the choices for a present evaluation content and let the user manually choose among the narrowed down choices. Alternatively, the evaluation system 101 may provide instructions or recommendations to guide the choice by the user. The user may select an evaluation content by mouse clicking.

At block 222, the evaluation system 101 receives a feedback of the user 181 on the evaluation content. A feedback of a user on an evaluation content includes a feedback content itself (e.g., user answers), and may also include supplemental information such as the speed of users providing the feedback content. The feedback speed includes information of the time the user spent in the evaluation content.

At block 223, the evaluation system 101 analyzes the feedback of the user 181 based on the solution contents 113 to obtain an analysis result. An analysis result may be a simple analysis result of the accuracy of a feedback of a user. In cases where the evaluation content has multiple questions, the analysis result may be a percentage score calculated based on correct answers. If separate scores are assigned individually to each question, the analysis result may be the final score obtained. Alternatively, the analysis result may be manifested as a grade mark (such as unsatisfactory, satisfactory, good and excellent).

At block 224, the evaluation system 101 determines a subsequent evaluation content or a subsequent knowledge point for the user 181. The determination may be based on multiply information such as the analysis result, a multilevel arrangement of the evaluation content and a characteristic information of the user 181. The subsequent evaluation content may or may not (usually not) be the same as the present evaluation content.

The above completes a cycle of user study. After evaluation system 101 has made a determination of the subsequent evaluation content, the process may return to block 221 and repeat the blocks 221, 222, 223 and 224 to complete another cycle of user study. For example, after the evaluation system 101 provides the subsequent evaluation content to the user 181, the user may start work on the newly received evaluation content and provide a new feedback with respect to the new evaluation content. The evaluation system can execute blocks 222-224 again in the new context with the new evaluation content, which becomes the present evaluation content in relation to the present cycle.

In one embodiment, the evaluation system 101 assigns a user identification (ID) to each user and establishes a user data set in association with the user identification. The evaluation system 101 updates the user data set of the present user according to the feedback of the user with respect to the present evaluation content. The user data set may have a plurality of user data subsets each associated with one or more evaluation contents. In some embodiments, the user data subsets may be organized according to knowledge points. For example, each data subset may correspond to a knowledge point evaluated by one or more evaluation contents.

The data set of each user may store a variety of history information 116 of using the evaluation system 101 by the user. The history information 116 may include such information as a selection track of the evaluation contents by the user, feedbacks and feedback speeds for the evaluation contents, and analysis results of the feedbacks of the user. Preferably, the data set of each user stores at least previous feedbacks of the user on one or more other evaluation contents of the evaluation contents 112 and/or the system analysis results of the user's previous feedbacks on the one or more other evaluation contents. In one embodiment, the evaluation system 101 organizes the evaluation contents 112 into a multilevel arrangement according to a multilevel arrangement of knowledge points that are being assessed by the evaluation content. In this case, the data set of each user may be divided into multiple sub-data sets where each sub-data set is used for storing the feedbacks of the user on one or more evaluation contents corresponding to a certain knowledge point or a group of knowledge points, and/or the analysis results of such feedbacks.

At block 224 as shown in FIG. 2, the evaluation system 101 may also determine the subsequent evaluation content or the subsequent knowledge point for the user based on the present analysis result and the history information 116 stored in the user's data set. The history information 116 may include the stored feedbacks of the user on one or more other evaluation contents, and/or the stored analysis results of such feedbacks.

For example, for an evaluation content which is used for assessing a knowledge point “Area of a Rectangle”, if the evaluation system 101 determines that an answer of the user is incorrect according to a pre-stored answer, this result alone may indicate that the user is not good at “Multiplication” or does not fully understand of the concept of “Area of a Rectangle”, or both, but may not have enough information to determine which one it is.

However, if the data set of the same user has stored the previous feedbacks of the user on the evaluation contents for assessing “Multiplication” and/or the system analysis results of the these feedbacks, the evaluation system 101 may be able to determine whether this user has already learned “Multiplication” well. For example, the evaluation system may determine that a percentage of correct answers given by the user concerning “Multiplication” is greater than a preset threshold, and therefore conclude that this user has already satisfactorily learned multiplication. If the data set already has stored an analysis result of the user's feedbacks on “Multiplication”, the evaluation system may discern whether the user has understood “Multiplication” directly from the analysis result without performing further analysis.

If the evaluation system 101 concludes that the user has already understood “Multiplication” based on the stored history information 116 of the user, the evaluation system 101 may conclude that the user's problem is more likely that he or she does not fully understand the concept of “Area of a Rectangle”. The evaluation system 101 may therefore decide that an evaluation content for “rectangle area formula” in the knowledge point “Area of a Rectangle” should be the subsequent evaluation content for the user to learn or practice, and/or that a knowledge point “Area of a Rectangle” should be the subsequent knowledge point for the user to study.

If the evaluation system 101 concludes that the user has not fully understood “Multiplication” based on the history information 116 of the user, the evaluation system 101 may decide that an evaluation content of “Multiplication” should be the subsequent evaluation content for the user.

Preferably, the characteristic information 115 of a user may also include basic information 117 of the user, such as personal information of the user including gender, age, school grade, school, geographical location, and favorite subjects. If the user is a minor, the basic information may further include parental information such as educational background and occupation of the guardian(s) (e.g., parents). A user's basic information 117 may be taken the first time the user uses the evaluation system. The evaluation system may require the user to enter the relevant personal information.

The evaluation system may determine an initial evaluation content for the user based on part or all of the basic information of the user. For example, according to the school grade of the user, an evaluation content equivalent to evaluation contents of that school grade may be provided to the user. A comprehensive set of evaluation contents may be provided to the user as a placement test. Because a new user may have not accumulated any history information, the initial evaluation content may be determined primarily based on the basic information of the user. Alternatively, the evaluation system may let the user choose an evaluation content manually, or based on a system suggestion. As the user starts to work on the evaluation contents provided and returns relevant feedback to the evaluation system, the evaluation system may start to determine the subsequent evaluation content or the subsequent knowledge point for the user based on the analysis result of the feedback and the multilevel arrangement of multiple evaluation contents, either in place of or in addition to the basic information of the user. The exact model of making such a determination, for example, how much weight is given to each type of information, may vary and can be adjusted according to the effect that experience.

For instance, assume a user of age ten studying in primary three for illustration. Suppose when the user first uses the evaluation system, the user selects an evaluation content related to “Calculus” in Advanced Mathematics as the present evaluation content. Because the user has never learned calculus and is further unprepared for such an advanced subject, the user is likely to return very poor feedback on the initial evaluation content provided. Consequently, at block 224 the evaluation system may determine that “calculus” is an improper study subject and provide a subsequent evaluation content associated with a more appropriate knowledge point which is commensurate with the level of the user's apparent ability according to the age and the school grade of the user to be studied by the user.

In one embodiment, at block 224, the evaluation system 101 may also first determine whether the analysis result in block 223 satisfies a first condition or criterion (e.g., whether the analysis result indicates a value greater than or equal to a first preset threshold). If the analysis result satisfies the first condition, the evaluation system 101 decides that the user has satisfactorily learned the present evaluation content and may progress to the next evaluation content in the multilevel arrangement of the evaluation contents. Accordingly, the evaluation system 101 determines that an evaluation content next to the present evaluation content in the multilevel arrangement of the evaluation contents be the subsequent evaluation content for the user. Here, an evaluation content is considered “next” to a present evaluation content in the multilevel arrangement when moving from the present evaluation content to the next evaluation content is considered continuously progressive (i.e., advancing naturally without an excessive gap) or at least not retrogressive. For example, an evaluation content that is at the same or a higher level in the multilevel arrangement relative to the present evaluation content is a next evaluation content relative to the present evaluation content.

Take an evaluation content of a knowledge point “Addition of Integers within One Hundred” as an example. Assume that the evaluation content has ten questions and the first preset threshold is 80%. The evaluation system 101 analyzes feedbacks of the user on these ten questions according to the answers in the solution contents 113. If the analysis result shows that eight out of ten questions are answered correctly, the analysis result may be quantified to have a value greater than or equal to 80%, and the evaluation system 101 concludes that the user has understood the concept. Based on the multilevel arrangement of evaluation contents 112, the evaluation system 101 determines that an evaluation content next to the present evaluation content in the multilevel arrangement of the evaluation contents be the subsequent evaluation content for the user.

In another embodiment, at block 224 the evaluation system 101 may determine whether the analysis result in block 223 is below a second condition or criterion (e.g., whether the analysis result indicates a value smaller than a second preset threshold). If the analysis result is below the second condition, it may indicate that the user has not satisfactorily learned the present evaluation content. Accordingly, the evaluation system 101 may decide that an evaluation content of the same or a lower level (such as a lower difficulty level but for the same knowledge point) compared with the present evaluation content be the subsequent evaluation content for the user. In this determination, the level of an evaluation content is determined by the multilevel arrangement of the evaluation contents. Alternatively, one or more knowledge points that are being assessed by the said evaluation content may be determined to be the subsequent knowledge point studied by the user.

An exemplary second preset threshold is 70%. The evaluation system 101 analyzes feedbacks of the user on the above-described ten questions according to the pre-stored answers. If the analysis result shows that at least four out of ten questions are answered incorrectly, the quantified analysis result is smaller than 70%, and is thus below the second condition.

Still use the above example and further assume that the user has previously provided feedbacks on evaluation contents of knowledge points “Addition of Integers within Twenty” and “Addition of Integers within Ten”. Also assume that the evaluation system 101 has recorded in a data set for the user the characteristic information 115 of the user. The characteristic information 115 include history information 116 such as the feedbacks of the user on the evaluation contents of knowledge points “Addition of Integers within Twenty” and “Addition of Integers within Ten” and the analysis results of the feedbacks of the user. Based on the existing information related to the user, the evaluation system 101 may determine that the subsequent evaluation content to be provided to the user should be an evaluation content of the knowledge point “Addition with Twenty”, an evaluation content of the knowledge point “Addition with Ten”, or an evaluation content of the knowledge point “Addition with Hundred”.

Specifically, based on the characteristic information 115 of the user recorded, the evaluation system 101 may find that the feedback of the user on the evaluation content of the knowledge point “Addition of Integers within Ten” is satisfactory (e.g., has an analysis result value greater than a first preset threshold), and the feedback of the user on the evaluation content of the knowledge point “Addition of Integers within Twenty” is unsatisfactory (e.g., has an analysis result value smaller than a second preset threshold), and thus concludes that the evaluation content of the knowledge point “Addition of Integers within Twenty” should be the subsequent evaluation content for the user.

If the evaluation system 101 observes that the feedbacks of the user on the evaluation contents of the knowledge points “Addition of Integers within Ten” and “Addition of Integers within Twenty” are both satisfactory (e.g., each has an analysis result greater than a respective first preset threshold), and also observes that the feedback speed of the user on the present evaluation content (i.e., the evaluation content of the knowledge point “Addition of Integers within One Hundred”) is sufficiently fast (e.g., faster than a preset threshold for feedback speed), the evaluation system 101 may conclude that the user has made those mistakes by accident or carelessly, and determines that another evaluation content that assesses the knowledge point “Addition of Integers within One Hundred” be the subsequent evaluation content for the user.

It should be noted here that the first preset threshold may or may not be the same as the second preset threshold. For example, the first preset threshold may be greater than the second preset threshold. If an analysis result falls in between the first and the second preset thresholds, the evaluation system may adopt different strategies to determine the subsequent evaluation content or the subsequent knowledge point for the user. For example, in this circumstance, the evaluation system may continue to provide similar evaluation contents (e.g., evaluation contents of same or similar difficulty level associated with the same knowledge point) to the user until the first condition is satisfied so user may progress to the next level.

To assist further understanding of the present disclosure, the present disclosure is described in further details using an example of organizing evaluation contents into a multilevel arrangement by the evaluation system according to a multilevel arrangement of knowledge points that are being assessed by the evaluation contents. Using knowledge point differentiation, a certain subject or part of the subject is differentiated into many knowledge points that have a multilevel arrangement. Each knowledge point has one or more corresponding evaluation contents such as exercises and test questions. The exercises and test questions of each knowledge point are divided into different difficulty levels based on their degrees of difficulty. Each difficulty level includes exercises of equivalent difficulty level and a group of test questions. The exercises and test questions of each knowledge point may also be divided into different comprehensiveness levels based on their degrees of comprehensiveness.

Assume that the evaluation content of the knowledge point “Addition of Hundred” is divided into five difficulty levels with increasing difficulty from level one to level five, and the present evaluation content belongs to the second difficulty level. The present evaluation content has ten exercises and the first preset threshold is 80%. The evaluation system 101 analyzes feedbacks of the user on these ten exercises, and the analysis result shows that at least eight out of ten exercises are answered correctly. The quantified analysis result is thus greater than or equal to 80%, and therefore the evaluation system 101 determines that the user has understood the evaluation content of the present difficulty level. The evaluation system 101 then determines, based on the multilevel arrangement of evaluation contents, whether a different type of evaluation content (e.g., test questions) corresponding to the present difficulty level or an evaluation content of a higher difficulty level (e.g., the third difficulty level) should be the subsequent evaluation content for the user. In one example, the evaluation system 101 first provides a test question group of the present difficulty level to the user for further evaluation. If the user also passes the test question group (i.e., receives an analysis result meeting the first condition), the evaluation system 101 then provides the evaluation content of a higher difficulty level to the user.

The above level differentiation is but one example of a multilevel arrangement of evaluation contents. Level differentiation may have any structure and granularity as desired or needed. At each level, sub levels may also be used. For example, the addition of numbers within one hundred may belong to a certain level. At this level, questions and exercises may be classified into multiple sub levels. Such classification or grouping defines the detailed structure of the multilevel arrangement of evaluation contents.

It is appreciated that requiring an analysis result value greater than the first preset threshold is but only one example of the first condition. With respect to the present exercises in the above example, it may be considered as fulfilling the first condition if the user answers a certain number of exercises correctly. Alternatively, it may be considered as fulfilling the first condition if the user finishes the exercises correctly within a preset period of time. The first condition may also be a combination of several sub-conditions such as a concurrent satisfaction of a threshold for correct answers and another threshold for completion speed.

Suppose that the second preset threshold is 70%. The evaluation system 101 analyzes the feedbacks of the user on these ten exercises, and gives an analysis result which shows that at least four out of ten exercises are answered incorrectly. The quantified analysis result is smaller than 70%, or below the second preset threshold. The evaluation system 101 therefore concludes that the user has not fully understood the evaluation content of the present difficulty level. Based on the multilevel arrangement of evaluation contents, the evaluation system 101 then determines that the evaluation content of a lower difficulty level (e.g., the first difficulty level) should be the subsequent evaluation content for the user. Alternatively, the evaluation system 101 may determine that one or more knowledge points that are being assessed by the present evaluation content should be the subsequent knowledge point studied by the user.

The evaluation system 101 may also include one or more sets of comprehensive evaluation questions. In one embodiment, each set of the comprehensive evaluation questions has a hierarchical structure which has the following levels of evaluation contents: an higher level evaluation content used for assessing a set of multiple knowledge points; and a lower level evaluation content (relative to the higher level evaluation content) used for assessing evaluation contents of a subgroup of knowledge points. For example, an evaluation content for assessing a knowledge point set {A, B} and an evaluation content for assessing a knowledge point set {C, D} are lower level evaluation contents relative to an evaluation content for assessing a knowledge point set {A, B, C, D}, and vice versa. The knowledge points A, B, C and D may or may not have any particular inter-relations in the arranged structure.

Various types of evaluation contents may be provided in different orders or in a mixed manner. For example, the evaluation system 101 may first provide evaluation contents of the exercises and test questions for a knowledge point (or a group of knowledge points) as the present evaluation content to the user, and subsequently provide comprehensive evaluation questions after the user has satisfied a condition set for the exercises and test questions. Alternatively, the evaluation system 101 may first provide one or more the comprehensive evaluation questions to the user as the present evaluation content and decide the type of evaluation contents to be provided next based on the feedback of the user. For example, the evaluation system 101 may determine whether the analysis result of the comprehensive evaluation questions is below a requirement (e.g., whether the answer is wrong). If the analysis result is below the requirement, the evaluation system 101 may provide more focused evaluation contents for further evaluation, or provide one or more lower level evaluation contents relative to the present evaluation content to the user.

Preferably, the evaluation system may also consider the history information of the user such as stored feedbacks of the user when determine the one or more lower level evaluation contents to be the subsequent evaluation content for the user.

Without loss of generality, the following uses an example in which knowledge points that are assessed by evaluation contents are arranged in a hierarchical structure for illustration. An exemplary hierarchical structure of evaluation contents is defined as follows: an evaluation content used for assessing a higher level knowledge point is a higher level evaluation content, while an evaluation content used for assessing one or more lower level knowledge points of the higher level knowledge point is a lower level evaluation content relative to the higher level evaluation content. Some knowledge points may be considered to be at the same level, and their associated evaluation contents may also be considered to be at the same level accordingly. The hierarchical structure of evaluation contents may be defined using other types of level differentiation methods, either in addition to the above exemplary level differentiation or alternatively. For example, for a given knowledge point, the evaluation contents may be further divided using more refined level differentiation such as types, difficulty levels and comprehensiveness levels.

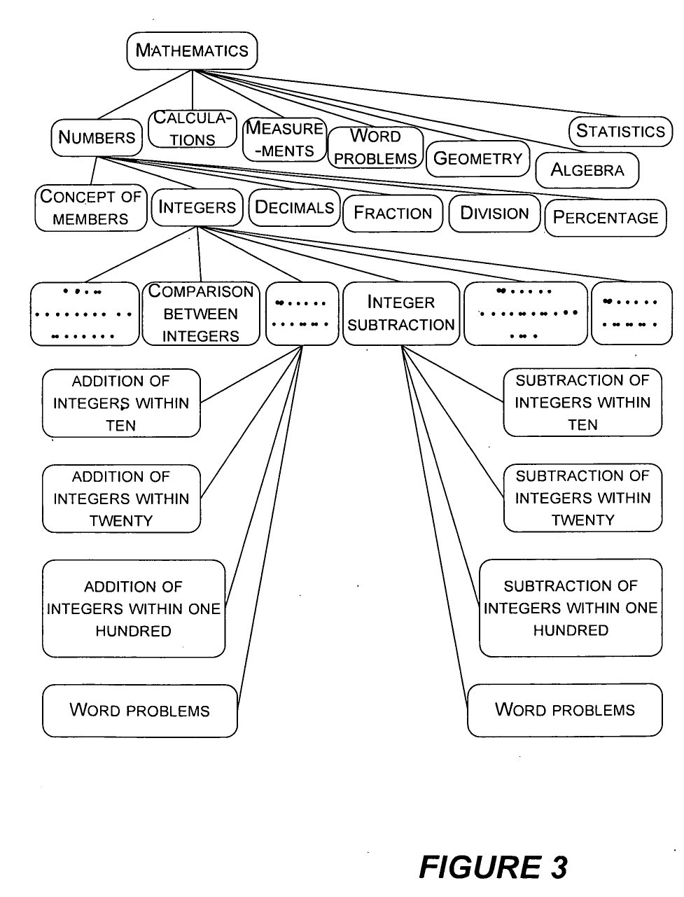

FIG. 3 illustrates an exemplary tree structure of knowledge points in Elementary Mathematics in accordance with the present disclosure. In the exemplary tree structure, the knowledge of Elementary Mathematics is differentiated (divided) through multiple levels to the most elemental level at which any further differentiation of the knowledge points would not have any cognitive significance, or no longer help the learning experience of the user. As shown in FIG. 3, the subject of Elementary Mathematics is first differentiated into first level knowledge points—“Numbers”, “Calculations”, “Measurements”, “Applications” (or “Word Problems”), “Shapes”, “Algebra”, and “Statistics”. “Numbers” is selected to illustrate the differentiation of the next level. As shown, “Numbers” is then further differentiated into multiple second level knowledge points, such as “Concept of Numbers”, “Integers”, “Decimals”, “Fractions”, “Division”, “Percentage” and “Ratio and Proportion”. “Integers” is then selected to illustrate the differentiation (division) of the next level. As shown, “Integers” is differentiated into third level knowledge points such as “Basic Concept of Integers”, “Comparison between Integers”, “Integer Addition”, “Integer Subtraction”, “Integer Multiplication” and “Integer Division”. Finally, “Integer Addition” and “Integer Subtraction” are selected to illustrate the lowest level differentiation. Specifically, “Integer Addition” can further be differentiated into fourth level knowledge points—“Addition of Integers within Ten”, “Addition of Integers within Twenty”, “Addition of Integers within One Hundred”, “Word problems for Addition”. Similarly, “Integer Subtraction” can further be differentiated into fourth level knowledge points—“Subtraction of Integers within Ten”, “Subtraction of Integers within Twenty”, “Subtraction of Integers within One Hundred”, “Word Problems for Subtraction”. In the example of FIG. 3, the fourth level knowledge points are the most elemental level knowledge points.

It is appreciated that knowledge points associated with a certain subject matter may constitute a family of knowledge points. Different families of knowledge points may or may not be related. Within the same family tree, there are levels but there may also be orders within the same level demanding or recommending a particular sequence of learning.

It is also appreciated that the use of “first level knowledge point”, “second level knowledge point” and so on has no special meaning other than for an illustrative purpose of describing the logical relationship between knowledge points.

Corresponding to the tree structure of the knowledge points in FIG. 3, an evaluation content for assessing a knowledge point “Integer Addition” is a higher level evaluation content, while evaluation contents for assessing knowledge points “Addition of Integers within Ten”, “Addition of Integers within Twenty”, “Addition of Integers within One Hundred” and “Word problems for Addition” are lower level evaluation contents, relative to each other.

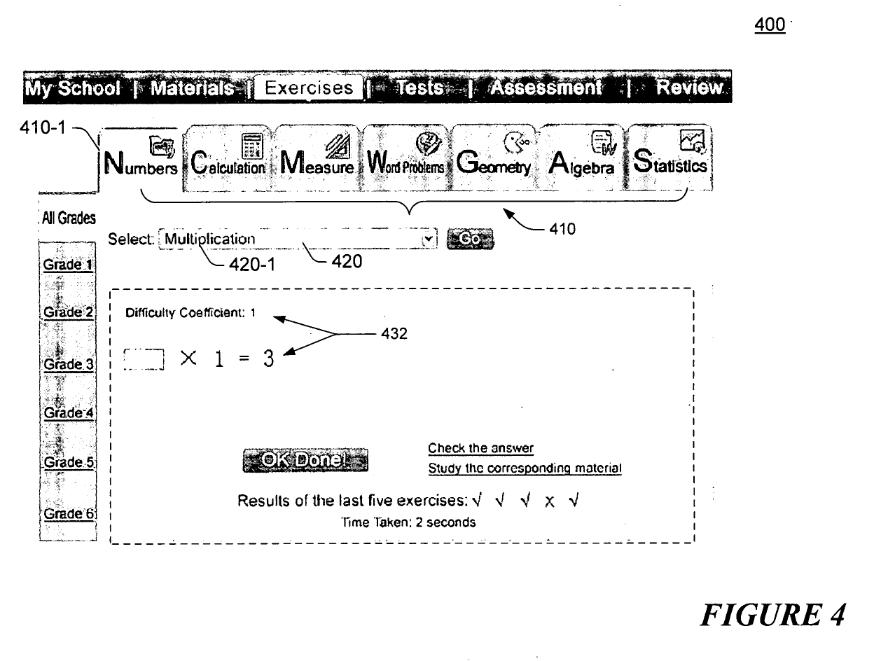

FIG. 4 illustrates a webpage-based user interface of an exemplary evaluation system 101 in accordance with the present disclosure. After a user logs into the evaluation system 101, a webpage 400 as shown in FIG. 4 is displayed to the user by the evaluation system 101. Shown in the example of FIG. 4 are first level knowledge points 410 of an entry-level mathematical subject. Specifically, the first level knowledge points 410 include “Numbers”, “Calculation”, “Measure”, “Word Problems”, “Shapes”, “Algebra” and “Statistics”. The user may select one of the first level knowledge points 410-1 to browse knowledge points at lower levels 420 (which are subtopics of the selected first level knowledge point 410). The user may alternatively choose a knowledge point and select an evaluation content of that knowledge point. Evaluation contents of a knowledge point include may include multiple types of questions (e.g., exercises, tests and comprehensive evaluations) for the knowledge point. Prior to selecting a knowledge point, the user may choose the type of evaluation content. Before the user selects a knowledge point, the evaluation system 101 may provide a default knowledge point and its evaluation content to the user. For example, in FIG. 4, the first level knowledge point “Number” and its corresponding evaluation content 432 “_{—}×1=3” are presented to the user. Alternatively, the user may choose a knowledge point first, and let the evaluation system 101 provide links to different types of evaluation contents to the user for manual selection by the user.

Turning back to FIG. 2, in one embodiment, at block 224 of FIG. 2, the evaluation system 101 determines whether the analysis result of block 223 is below a third condition (e.g., an analysis result value smaller than a third preset threshold). If the analysis result is below the third condition, it may indicate that the user not only has not learned the present evaluation content at the present level, but may have not understood the related knowledge point at all. The evaluation system may decide that the user needs to step back to learn lower level evaluation contents or even lower level knowledge points. Accordingly, the evaluation system determines that one or more lower level evaluation contents relative to the present evaluation content be the subsequent evaluation content for the user. Alternatively, the evaluation system provides one or more comprehensive evaluation contents to further evaluate the learning status of the student and determining what evaluation content should be provided the next.

It should be appreciated that the above-discussed third preset threshold may or may not be the same as the first preset threshold or the second preset threshold. The specific values of the first, the second and the third preset thresholds may be set against an absolute standard, or dynamically adjusted according to the actual difficulty of the evaluation content and the feedback of the user. The values of the first, the second and the third preset thresholds may vary from time to time, and may be different for different study subject matters, different types of users, and different evaluation contents. The values of the first, the second and the third preset thresholds may be set independently from each other. Furthermore, either less than three or more than three different thresholds may be used to achieve a desired evaluation effect.

In this disclosure, the level of an evaluation content is a relative and variable concept, and is defined in the multilevel arrangement of the evaluation contents. Levels can be defined differently using different schemes to have different multilevel arrangements. The level differentiation between evaluation contents may consider various factors but is usually guided by a goal to achieve a better learning experience. One example of level differentiation is difficulty levels among the evaluation contents used for assessing the same knowledge point or the same group of knowledge points. Another example of level differentiation is the level of comprehensiveness of evaluation contents, with an evaluation content that covers a larger number of knowledge points being considered a higher level evaluation content relative to another evaluation content that covers a smaller number of knowledge points. Yet another example of level differentiation is the level of knowledge points associated with the evaluation content, with an evaluation content that is used for assessing a higher level knowledge point being considered a higher level evaluation content relative to another evaluation content that is used for assessing a lower level knowledge point.

For example, assume that an evaluation content for assessing the knowledge point “Integer Addition” has twenty questions, and the third preset threshold is 60%. The evaluation system analyzes the feedbacks of the user on these twenty questions according to pre-stored answers. If the analysis result shows that fewer than twelve out of the twenty questions are answered correctly, i.e., the quantified analysis result is smaller than or equal to 60%, the evaluation system determines that the user has not fully understood the knowledge point that is being assessed by the present evaluation content. Based on the multilevel arrangement of evaluation contents, the evaluation system determines that some of lower level evaluation contents relative to the present evaluation content of “Integer Addition” be the subsequent evaluation contents for the user. For example, one or more evaluation contents for “Addition of Integers within Ten”, “Addition of Integers within Twenty”, “Addition of Integers within One Hundred” and “Word problems for Addition” may be determined to be the subsequent evaluation contents for the user.

To illustrate further determination, assume that the evaluation system 101 has recorded in the user's data set the characteristic information 115 of the user, including the history information 116 of the user (i.e., the feedbacks of the user on the evaluation contents of knowledge points “Addition of Integers within Twenty” and “Addition of Integers within Ten”, and the system analysis results of the feedbacks of the user). Based on the recorded characteristic information 115 of the user, the evaluation system 101 may find that the feedback of the user with respect to the evaluation contents of the knowledge point “Addition of Integers within Ten” is already satisfactory (e.g., has an analysis result value greater than a respective first preset threshold), but the feedback of the user on the evaluation content of the knowledge point “Addition of Integers within Twenty” is unsatisfactory (e.g., has an analysis result value smaller than a respective second preset threshold). Accordingly, the evaluation system 101 narrows down the selections and determine that an evaluation content of the knowledge point “Addition of Integers within Twenty” should be the subsequent evaluation content for the user.

Likewise, if the evaluation system observes that the feedbacks of the user on the evaluation contents of both knowledge points “Addition of Integers within Ten” and “Addition of Integers within Twenty” are satisfactory, the evaluation system may determine that evaluation contents of the knowledge points “Addition of Integers within One Hundred” or “Word Problems” be the subsequent evaluation content for the user.

If the characteristic information of the user indicates that the feedbacks of the user on the evaluation contents for the knowledge points “Addition of Integers within Ten”, “Addition of Integers within Twenty”, “Addition of Integers within One Hundred” and “Word Problems” are all satisfactory, the evaluation system 101 may determine that the user must have made the mistakes accidentally or carelessly, and thus decide that another evaluation content that assesses, for example the knowledge point “Addition of Integers within One Hundred”, be the subsequent evaluation content for the user for further practice or diagnosis.

In contrast, in the above example, if the analysis result shows that more than sixteen out of the twenty questions are answered correctly, that is, the quantified analysis result is greater than or equal to 80%, the evaluation system 101 may conclude that the user has understood the knowledge point that is being assessed by the present evaluation content and is ready to move to a next evaluation content or knowledge point. Accordingly, the evaluation system 101 may conclude that an evaluation content for assessing a knowledge point next to the present knowledge point “Integer Addition” in the multilevel arrangement of knowledge points be the subsequent evaluation content for the user. Specifically, as shown in FIG. 3 for example, an evaluation content for assessing “Integer Multiplication” may be determined as the subsequent evaluation content for the user.

Preferably, at block 224, the evaluation system 101 may determine the subsequent evaluation content or the subsequent knowledge point for the user by giving consideration to a combined variety of information. For example, the determination may be made based on the analysis result obtained at block 223, the multilevel arrangement of evaluation contents, the characteristic information of the user, and the characteristic information of other users, with any combination and with any weights given to each type of information. Here, the characteristic information of other users are stored in datasets of these other users and may include the feedbacks of one or more users other than the present user 181 and/or the system analysis results of these feedbacks of the other users.

Continuing with the previous example, suppose that the present evaluation content is an evaluation content associated with the knowledge point “Addition of Integers within One Hundred”. If the percentage accuracy for these twenty questions is smaller than or equal to 60%, the evaluation system determines that the user has not fully understood the knowledge point “Addition of Integers within One Hundred” that is being assessed by the present evaluation content. Based on the multilevel arrangement of evaluation contents, the evaluation system determines that one or more lower level evaluation contents relative to the present evaluation content of “Addition of Integers within One Hundred” should be the subsequent evaluation contents for the user. From this point, other types of information are then further considered to narrow down the choices.

For example, suppose the characteristic information of the user only has the feedbacks of the user on the evaluation contents of the knowledge point “Addition of Integers within Ten” and/or the system analysis results of the feedbacks. If the evaluation system 101 determines that the feedbacks of the present user on the evaluation contents of the knowledge point “Addition of Integers within Ten” are satisfactory (e.g., has an accuracy greater than or equal to 80%), the evaluation system 101 may determine that one or more evaluation contents of the other knowledge points under “Integer Addition”, namely “Addition of Integers within Twenty”, “Addition of Integers within One Hundred” or “Word Problems”, be the subsequent evaluation content for the user.

Furthermore, suppose the characteristic information of the other users includes feedbacks on the evaluation contents of the knowledge points under “Integer Addition”, including “Addition of Integers within Ten”, “Addition of Integers within Twenty”, “Addition of Integers within One Hundred” and “Word Problems”, and/or the system analysis results of the respective feedbacks. The evaluation system 101 may refer to the feedbacks of the other users on the evaluation contents of these knowledge points or the system analysis results of such feedbacks to determine which evaluation content should be chosen as the subsequent evaluation content for the user. For example, if the evaluation system 101 determines from the other users' records that the feedbacks of most users on the evaluation contents of “Addition of Integers within Twenty” are satisfactory quickly or immediately after they have satisfactorily learned the knowledge point “Addition of Integers within Ten”, the evaluation system 101 may conclude that the knowledge point “Addition of Integers within Twenty” may be skipped for a user who has demonstrated good results on the knowledge point “Addition of Integers within Ten”. The evaluation system 101 may reach this conclusion especially when it recognizes the present user as a fast learner based on the user's historic information. Accordingly, the system may decide that the present user no longer needs to work on evaluation contents of “Addition of Integers within Twenty” or any other similarly simple or simpler knowledge points under “Integer Addition”, and therefore may select an evaluation content of “Addition of Integers within One Hundred” to be the subsequent evaluation content for the present user.

The above concept of “skipping” may apply to evaluation contents at any level or position in the multilevel arrangement of the evaluation contents. For example, the skipping may also be applied among the different types of evaluation contents associated with the same knowledge point or different knowledge points.

In principle, the evaluation system 101 may have a very detailed multilevel arrangement of evaluation contents as a base or master multilevel arrangement, but may use the multilevel arrangement of evaluation contents differently for different users. For example, if the evaluation system recognizes that a particular user is a fast learner based on the user's learning history (historic information), the system may be more inclined to skip certain minor steps or levels in the detailed base or master multilevel arrangement for this particular student. To do this, the evaluation system may first determine from the historical information of the user if the user has a learning ability satisfying a certain aptitude condition. The aptitude condition may be predefined and can either be fixed or dynamically adjusted. There is no restriction as to what specific type of aptitude condition should be used and how the aptitude condition of the user is evaluated. If the evaluation system determines that the user's learning ability satisfies the aptitude condition, the evaluation system may skip a next evaluation content relative to the present evaluation content in the multilevel arrangement of the evaluation contents and select a further next evaluation content relative to the next evaluation content in the multilevel arrangement to be the subsequent evaluation content.

In other words, the base or master multilevel arrangement of evaluation contents may have a high level “resolution” with respect to the differentiation of evaluation contents and the knowledge points, but the evaluation system may render the evaluation contents and the knowledge points to certain users at lower resolutions by skipping certain minor steps or levels.

To make the above decision, the evaluation system may also consider feedbacks of other users. For example, if the feedbacks of other users show that most users progress from a certain point in the multilevel arrangement to another point quickly, or even automatically, the system may be even more inclined to decide that the present student may skip this step.

The feedbacks of the other users may be used to influence the selection of the subsequent evaluation content in a variety of ways. For example, if the present user has joined with another user in a coordinated study, such as a study competition, the record of the feedbacks of the other user may be used in the selection of the subsequent evaluation content of the present user. For instance, if the feedback record of the other user shows that the other user has answered a certain question in a certain type of evaluation content, the evaluation system 101 may recommend the same question to the present user, or let user choose the same question to answer. A coordinated study, such as study competition, may be joined by any number of users, either on the basis of voluntary user selection, or by organization administered by the evaluation system.

Preferably, the evaluation system 101 may divide users into groups based on basic information of each user. The evaluation system 101 may determine the subsequent evaluation content or the subsequent knowledge point for the user based on the information of the user group to which the present user belongs, in addition to the other information including the analysis result of the feedback on the present evaluation content, the multilevel arrangement of evaluation contents, the characteristic information of the present user. The information of the user group is stored in the data sets of the users in the group, and may include the feedbacks of the users in the group on one or more evaluation contents and/or the analysis results of the feedbacks.

Preferably, the evaluation system 101 may also provide an opportunity for user-provided materials and interaction among users. If a user has some very good evaluation contents, for example, the user may share the evaluation contents with other users through the evaluation system 101. Specifically, the evaluation system may receive a user-provided evaluation content from a user and store the evaluation content in association with other related evaluation contents (system-provided or user-provided) for the use of the user himself and/or other users.

To better organize the evaluation contents, the evaluation system 101 may receive user ratings of evaluation contents and use the rating information, in addition to the other information discussed above, to determine the subsequent evaluation for a user. The user rating may be applied to all evaluation contents, both system-provided and user-provided, but may also be restricted to user-provided evaluation contents only. In one embodiment, the evaluation system 101 receives multiple user-provided evaluation contents related to the evaluation contents, further receives user ratings of the multiple user-provided evaluation contents, and determines a highly rated user-provided evaluation content by comparing one another among the user-provided evaluation contents. The highly rated user-provided evaluation content may be favorably provided to the user for study.

Preferably, the evaluation system 101 provides an option to allow users to perform a study review at any time. The evaluation system 101 receives from the present user an inquiry about the user's study/evaluation history and generates a response based on the inquiry. The response includes the information of the evaluation history inquired by the user. The evaluation system 101 sends the response to the user to allow or assist the user perform a review. The user inquiry may be specified by the user to include a certain type of evaluation history information within a time period (either user specified or system specified). For example, the user may indicate in the inquiry that the information related to questions that have been incorrectly answered by the user in the past be returned. A specific system response to such an inquiry will help user focus on areas that need reinforcement or a deeper impression and better understanding.

Opportunities for the user to review the study result may also be provided by the system without an explicit request by the user. For example, the system may determine a time to provide the analysis result of the user feedbacks and the associated solution contents. Such time may be every time after receiving a feedback of the user, or whenever the user has completed a certain amount of evaluation contents, such as a set of questions, or a set of evaluation contents related to a certain knowledge point.

The above-described are but just a few examples of determining the subsequent evaluation content based on the multilevel arrangement of the evaluation contents and the characteristic information of the users. Many variations may exist in the manners of determining the subsequent evaluation content based on the multiple types of information illustrated herein. The following is a summary of some examples.

1. Given multilevel arrangements of the knowledge points and the evaluation contents, the user may be allowed to freely choose any knowledge point and practice any evaluation content associated with the chosen knowledge point.

2. Given the knowledge point, the evaluation content system may start with the least difficult evaluation contents and let the user gradually work toward more difficult evaluation contents. The difficulty levels of the evaluation contents may be defined by the multilevel arrangement of the evaluation contents, as illustrated herein.

3. If the user has satisfactorily finished a certain evaluation content, the evaluation system 101 may be configured to become biased against providing the same evaluation content or the same type of evaluation contents to the same user in the future. For example, under such a circumstance, the evaluation system 101 may provide the same type evaluation contents only if the user specifically requests such evaluation contents (e.g., by clicking the designated button in the web interface communicate such a request).

4. If the user shows deficiency on a certain evaluation content, another evaluation content of similar type and/or similar difficulty level associated with the same knowledge point may be provided to the user for another chance. If the user does not show improvement, a different type or a lower level evaluation content associated with the same knowledge point may be provided to the user. If the user continues to show deficiency, a further lower level evaluation content associated with a related (e.g., preparatory) or a lower level knowledge point is provided.

5. If the user has demonstrated deficiency on a certain evaluation content, a number of evaluation contents containing questions or exercises designed to further diagnose the user's understanding of the related knowledge point(s) may be provided to the user, and different actions may be taken depending on the feedback of the user on the newly provided evaluation contents. For example, if the user answers all of the new questions correctly, it may indicate that the previous error was accidental or due to lack of carefulness. If the user answers a relatively low percentage of questions (e.g., 50%) correctly, it may indicate that the user has not learned the knowledge point well and may need evaluation contents with a lower difficulty level for further exercise. If the user answers a very low percentage of the questions (e.g. 20%) correctly, the evaluation system may suggest or direct the user to study certain instructional material related to the current knowledge point. If the user answers an extremely low or zero percentage of the questions correctly, the evaluation system may suggest or direct the user to study preparatory knowledge points of the current knowledge point.

In practice, the above methods may be used in combination. Furthermore, the history information of the user may be used in combination with any of the above methods.

The historic information of the user may include any useful or relevant information indicating a characteristic learning history of the user. Such information may include, but not limited to, history of doing the same question or the same kind of questions (e.g., the number of times the user has done a particular question or a certain type of questions in the past); correct rate on the same question or the same kind of questions; history of doing questions associated with a certain knowledge point (e.g., a number of questions the user has done associated with the knowledge point, and the correct rate); history of doing questions associated with the present knowledge point (e.g., number of questions done and the correct rate); history of doing questions associated with a knowledge point adjacent to the present knowledge point; and history of doing questions associated with a knowledge point at the next higher level relative to the present knowledge point. The history information of the user is accumulated and may be analyzed using various methods such as statistical methods any time when needed or deemed appropriate. The results of such analyses (i.e., analysis results) may also be recorded as part of the historic information of the user. That is, the historic information of the user may include raw data of the user's study history, or analysis results of the raw data, or both.

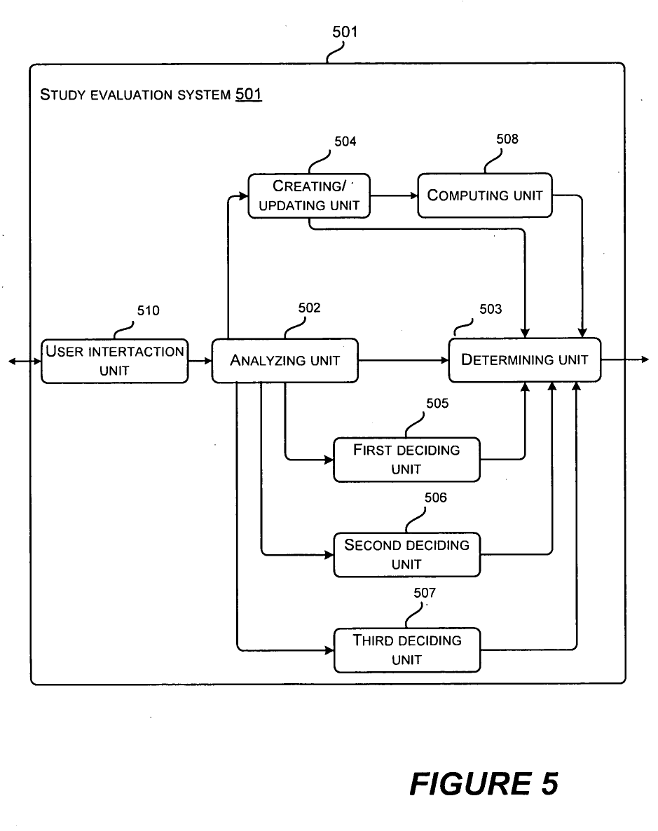

FIG. 5 shows a schematic structural diagram of an exemplary embodiment of the study evaluation system of the present disclosure. The study evaluation system 501 includes a user interaction unit 510, an analyzing unit 502, a determining unit 503, a creating/updating unit 504, a first deciding unit 505, a second deciding unit 506, a third deciding unit 507 and a computing unit 508. It is appreciated that many devices described herein are optional and only the user interaction unit 510, the analyzing unit 502 and the determining unit 503 are essential in the disclosed system 501. Furthermore, delineation of a first, a second, and so on for a certain device (e.g., first deciding unit 505 and second deciding unit 506) does not necessarily suggest that physically separate devices are used. Instead, the delineation may be only functional, and the functions of several devices may be performed by a single combined device.

In this description, a “unit” is a device which is a tool or machine designed to perform a particular task or function. A unit or device can be a piece of hardware, software, a plan or scheme, or a combination thereof, for effecting a purpose associated with the particular task or function.

The study evaluation system 501 may be implemented in a computing device, such as network server 102, in a similar fashion as the study evaluation system 101. The operation of the study evaluation system 501 is the same as the above-described in FIGS. 1-3, and is briefly summarized below.

First, the user interaction unit 510 interacts with a user and provides a present evaluation content to the user. As shown in FIG. 1, the evaluation system 501 may be implemented in a network server 102 which interacts with the user 181 through a user terminal 180 (or any other user terminal 182 or 184). For example, the user 181 may visit the website supported by the evaluation system 501 through the Internet and select an evaluation content by mouse clicking.

The user interaction unit 510 then receives a feedback on the present evaluation content from the user. The analyzing unit 502 analyzes the feedback of the user and obtains an analysis result. The determining unit 503 determines a subsequent evaluation content or a knowledge point for the user based on a variety of information including the analysis result, a multilevel arrangement of evaluation contents, characteristic information of the user (including the basic information of the user and the stored history information of the user), and the information of the other users. The subsequent evaluation content or the subsequent knowledge point is presented to the user by the user interaction unit 510 to start another study cycle. The user interaction unit 510, the analyzing unit 502 and the determining unit 503 repeat the process to accomplish a continuous evaluation of the user's study.

Preferably, the evaluation system 501 assigns a user ID to each user, and the creating/updating unit 504 creates or updates a data set related to the user ID for each user. The data set of each user may store variety of history information of the user as described herein.

The first time the user uses the evaluation system 501, the evaluation system 501 requires the user to enter his or her basic information. The evaluation system 501 decides, in one embodiment with the help of user interaction unit 510, a present evaluation content for the user based on part or all of the basic information of the user. For example, according to the school grade of the user, evaluation contents commensurate with the school grade may be provided to the user.

The analyzing unit 502 analyzes the user feedback on the provided evaluation content. In this process, several deciding units are used for various schemes of decision-making, as detailed in the description of FIGS. 1-3 described herein. For example, the first deciding unit 505 may first determine whether the analysis result made by the analyzing unit 502 is greater than or equal to a first preset threshold. If the analysis result is greater than or equal to a first preset threshold, the determining unit 503 determines that an evaluation content next to the present evaluation content in the multilevel arrangement of the evaluation contents be the subsequent evaluation content for the user.

The second deciding unit 506 may determine whether the analysis result made by the analyzing unit 502 is smaller than a second preset threshold. If the analysis result is smaller than a second preset threshold, the determining unit 503 determines that an evaluation content of the same or lower difficulty level compared to the present evaluation content be the subsequent evaluation content for the user. Alternatively, one or more knowledge points that are being assessed by the present evaluation content may be determined to be the subsequent knowledge point for the user.

The third deciding unit 507 determines whether the analysis result obtained by the analyzing unit 502 is smaller than a third preset threshold. If the analysis result is smaller than a third preset threshold, the determining unit 503 determines that one or more lower level evaluation contents of the present evaluation content be the subsequent evaluation content for the user based on the multilevel arrangement of evaluation contents.

The above first, second and third preset thresholds and the associated first, second, and third deciding units 505, 506 and 507 are only used for illustrating an example of the multi-layer and multifaceted decision making by the evaluation system disclosed herein. For example, the second preset threshold and the third preset threshold are used to differentiate different levels of “severity” of the deficiency of the user with respect to the present knowledge point and evaluation content being studied and assessed. It is appreciated that other schemes, including one that uses a more elaborate scheme having more than two or three preset thresholds, may be used.

The computing unit 508 may compute a statistics of the feedbacks of one or more other users on the evaluation contents. The feedbacks of the users are part of the history information 116 and are stored in the data sets of the users.

The operation of the evaluation system 501 has been described from a view of functionality. It is noted that the functions of the three deciding units (i.e., the first, the second and the third deciding units) are similar. Each deciding unit can be used to implement the functions of the other two deciding units. In practical terms, a single deciding unit could be used to perform the functions of all three.

Furthermore, the same or an additional deciding unit may be used to perform other functions as described in the context of the study evaluation method. For example, the deciding unit may be used for determining from the historical information of the user whether the user has a learning ability satisfying an aptitude condition. If affirmative, the study evaluation system 501 may skip a next evaluation content relative to the present evaluation content in the multilevel arrangement of the evaluation contents and selecting a further next evaluation content relative to the next evaluation content in the multilevel arrangement to be the subsequent evaluation content.

The exemplary embodiments of this disclosure have been described in detail above. It should be noted that each exemplary embodiment described may be implemented individually or in combination. In other words, the evaluation system in the present disclosure may include any number of the functions described in the exemplary embodiments and these functions may work interactively and enhance one another so as to provide a better individualized evaluation for the users.

It is appreciated that the potential benefits and advantages discussed herein are not to be construed as a limitation or restriction to the scope of the appended claims.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A study evaluation method using a computer-based study evaluation system including a plurality of evaluation contents each associated with at least one of a plurality of knowledge points, the plurality of evaluation contents being organized according to a multilevel arrangement, the method comprising:
(a) providing a present evaluation content to a user through user interaction, the present evaluation content being associated with a present knowledge point;
(b) receiving a feedback from the user with respect to the present evaluation content;
(c) analyzing the feedback of the user based on a solution content to obtain a present analysis result; and
(d) determining a subsequent evaluation content or a subsequent knowledge point to be studied by the user, at least partially based on the present analysis result, the multilevel arrangement and a characteristic information of the user.

2. The study evaluation method as recited in claim 1, wherein the study evaluation system assigns a user identification to the user and establishes a user data set in association with the user identification, the method further comprising:
updating the user data set according to the feedback of the user with respect to the present evaluation content.

3. The study evaluation method as recited in claim 2, wherein the user data set comprises a plurality of user data subsets each associated with one or more evaluation contents.

4. The study evaluation method as recited in claim 2, wherein the user data set includes at least one past feedback of the user with respect to one or more previous evaluation contents and/or an analysis result of the at least one past feedback by the study evaluation system, the characteristic information of the user includes information of the at least one past feedback and/or the analysis result of the at least one past feedback, and wherein determining the subsequent evaluation content or the subsequent knowledge point is conducted at least partially based on the present analysis result, the at least one past feedback and/or the analysis result of the at least one past feedback.

5. The study evaluation method as recited in claim 1, wherein the characteristic information of the user includes basic user information entered by the user.

6. The study evaluation method as recited in claim 5, wherein determining the subsequent evaluation content or the subsequent knowledge point is conducted at least partially based on the basic user information.

7. The study evaluation method as recited in claim 1, wherein determining the subsequent evaluation content or the subsequent knowledge point comprises:
determining whether the present analysis result satisfies a first condition, and if affirmative, selecting an evaluation content next to the present evaluation content at least partially based on the multilevel arrangement to be the subsequent evaluation content.

8. The study evaluation method as recited in claim 1, wherein determining the subsequent evaluation content or the subsequent knowledge point comprises:
determining whether the present analysis result is below a second condition, and if affirmative, selecting at least partially based on the multilevel arrangement an evaluation content which is related to and at the same or lower difficulty level than the present evaluation content to be the subsequent evaluation content, or selecting a knowledge point evaluated by the subsequent evaluation content to be the subsequent knowledge point to be studied by the user.

9. The study evaluation method as recited claim 8, wherein selecting the evaluation content to be the subsequent evaluation content or selecting the knowledge point to be the subsequent knowledge point is conducted at least partially based on the characteristic information of the user.

10. The study evaluation method as recited in claim 1, wherein the multilevel arrangement of the evaluation contents is at least partially determined according to a multilevel arrangement of the knowledge points which are evaluated by the evaluation contents.

11. The study evaluation method as recited claim 1, wherein the multilevel arrangement of the evaluation contents is at least partially determined by dividing evaluation contents associated with a knowledge point into multiple difficulty level groups, each group having one or more evaluation contents having approximately the same difficulty level.

12. The study evaluation method as recited in claim 1, wherein the multilevel arrangement of the evaluation contents comprises:
a first level containing one or more evaluation contents used for evaluating a group of knowledge points; and
a second level containing one or more evaluation contents used for evaluating a subgroup of the knowledge points in the group of knowledge points, wherein the first level is a higher level relative to the second level, while the second level is a lower level relative to the first level.

13. The study evaluation method as recited in claim 1, wherein the multilevel arrangement of the evaluation contents comprises:
a higher level containing one or more evaluation contents used for evaluating one or more higher level knowledge points; and
a lower level containing one or more evaluation contents used for evaluating one or more lower level knowledge points.

14. The study evaluation method as recited in claim 1, wherein determining the subsequent evaluation content or the subsequent knowledge point comprises:
determining whether the present analysis result is below a third condition, and if affirmative, selecting, at least partially based on the multilevel arrangement, an evaluation content which is at a lower level relative to the present evaluation content to be the subsequent evaluation content.

15. The study evaluation method as recited in claim 1, wherein determining the subsequent evaluation content or the subsequent knowledge point comprises:
determining whether the present analysis result is below a third condition, and if affirmative, selecting, at least partially based on the multilevel arrangement and a history information of the user, an evaluation content which is at a lower level relative to the present evaluation content to be the subsequent evaluation content, wherein the history information is a part of the characteristic information of the user and contains information of past feedback of the user with respect to one or more lower level evaluation contents relative to the present evaluation contents.

16. The study evaluation method as recited in claim 1, wherein the study evaluation system assigns a user identification to each of a plurality of users including the present user, establishes a user data set in association with each user identification, and updates the user data set of each user according to the feedback of the user with respect to evaluation contents presented to the user, and wherein determining the subsequent evaluation content or the subsequent knowledge point for the present user is conducted at least partially based on the multilevel arrangement, the characteristic information of the present user, and the user data of at least one user other than the present user who has provided a feedback with respect to the present evaluation content.

17. The study evaluation method as recited in claim 16, wherein the study evaluation system divides the plurality of users into multiple user groups, and the determining the subsequent evaluation content or the subsequent knowledge point for the present user is conducted at least partially based on the multilevel arrangement, the characteristic information of the present user, and the feedback and/or the analysis result of the feedback with respect to the present evaluation content contained in the data sets of users in the same group as the present user.

18. The study evaluation method as recited in claim 1, the method further comprising:
receiving from the user a user-provided evaluation content related to one of the plurality of evaluation contents; and
storing the user-provided evaluation content to be provided to the user and/or any other user for study evaluation.

19. The study evaluation method as recited in claim 1, the method further comprising:
receiving from multiple users user-provided evaluation contents related to at least one of the plurality of evaluation contents;
determining a highly rated user-provided evaluation content by comparing one another among the multiple user-provided evaluation contents to be provided for the user and/or any other user for study evaluation.

20. The study evaluation method as recited in claim 1, the method further comprising:
receiving from the user an inquiry of an evaluation history;
generating a response according to the inquiry, the response including the evaluation history information inquired by the user; and
sending the response to the user.

21. The study evaluation method as recited in claim 1, wherein the characteristic information of the user includes any one or a combination of the following basic information of the user:
gender; age; grade level; school(s) where the user is attending or has attended;
geographic location; education level of a guardian; occupation of a guardian;
and favorite study subject(s).

22. The study evaluation method as recited in claim 1, wherein the multilevel arrangement of the evaluation contents is at least partially determined according to a multilevel arrangement of the knowledge points which are evaluated by the evaluation contents, the multilevel arrangement of the evaluation contents including one or more of a tree structure, a pyramidal structure, a star structure, a chain structure, a ring structure and a grid structure of the evaluation contents.

23. The study evaluation method as recited in claim 1, wherein each evaluation content is characterized by its respective values of a set of attributes including at least one of “subject matter”, “related knowledge point(s)”, “evaluation type”, “difficulty level”, “comprehensiveness level”, and “grade level”.

24. The study evaluation method as recited in claim 23, wherein each evaluation content's respective values of the set of attributes are stored as a multi-field record of a database in which each attribute corresponds to a field of the record.

25. The study evaluation method as recited in claim 1, wherein the characteristic information of the user includes a historic information of the user, and wherein (d) comprises:
skipping a next evaluation content relative to the present evaluation content in the multilevel arrangement of the evaluation contents and selecting a further next evaluation content relative to the next evaluation content in the multilevel arrangement to be the subsequent evaluation content if the study evaluation system determines from the historical information of the user that the user has a learning ability satisfying an aptitude condition.

26. A system for study evaluation used for computer-based learning, wherein the system includes a plurality of evaluation contents each associated with at least one of a plurality of knowledge points, the plurality of evaluation contents being organized according to a multilevel arrangement, the system further comprising:
a user interaction unit for interaction with a user, including providing a present evaluation content to the user and receiving from the user a feedback with respect to the present evaluation content;
an analyzing unit for analyzing the feedback of the user based on a solution content to obtain a present analysis result; and
a determining unit for determining a subsequent evaluation content or a subsequent knowledge point to be studied by the user, at least partially based on the present analysis result, the multilevel arrangement and a characteristic information of the user.

27. The system as recited in claim 26, wherein the system assigns a user identification to the user and establishes a user data set in association with the user identification, the system further comprising:
a creating and updating unit for creating and updating the user data set according to the feedback of the user with respect to the present evaluation content.

28. The system as recited in claim 27, wherein the user data set includes at least one past feedback of the user with respect to one or more previous evaluation contents and/or an analysis result of the at least one past feedback by the system, the characteristic information of the user includes information of the at least one past feedback and/or the analysis result of the at least one past feedback, and the determining unit determines the subsequent evaluation content or the subsequent knowledge point at least partially based on the present analysis result, the at least one past feedback, and/or the analysis result of the at least one past feedback.

29. The system of claim 26, wherein the characteristic information of the user includes basic user information entered by the user, the user interaction unit is for further receiving the basic user information entered by the user, and the determining unit determines the subsequent evaluation content at least partially based on the present analysis result and the basic user information.

30. The system of claim 26, wherein the characteristic information of the user includes basic user information entered by the user, the user interaction unit is for further receiving the basic user information entered by the user, and the determining unit determines the subsequent evaluation content or the subsequent knowledge point at least partially based on the present analysis result, the multilevel arrangement of the evaluation contents, and the basic user information.

31. The system of claim 26, further comprising a deciding unit for deciding whether the present analysis result satisfies a first condition, and wherein, if affirmative, the determining unit is further used for selecting an evaluation content next to the present evaluation content according to the multilevel arrangement to be the subsequent evaluation content.

32. The system of claim 26, further comprising a deciding unit for deciding whether the present analysis result is below a second condition, and wherein, if affirmative, the determining unit is further used for selecting, at least partially based on the multilevel arrangement and the characteristic information of the user, an evaluation content which is related to and at the same or lower difficulty level than the present evaluation content to be the subsequent evaluation content, or a knowledge point evaluated by the subsequent evaluation content to be the subsequent knowledge point to be studied by the user.

33. The system of claim 26, wherein the multilevel arrangement of the evaluation contents is at least partially determined according to a multilevel arrangement of the knowledge points being evaluated by the evaluation contents.

34. The system of claim 26, further comprising a deciding unit for deciding whether the present analysis result is below a third condition, and wherein, if affirmative, the deciding unit is further used for selecting, at least partially based on the multilevel arrangement and a history information of the user, an evaluation content which is at a lower level relative to the present evaluation content to be the subsequent evaluation content, wherein the history information is a part of the characteristic information of the user and contains information of past feedback of the user with respect to one or more lower level evaluation contents relative to the present evaluation contents.

35. The system as recited in claim 26, wherein the characteristic information of the user includes any one or a combination of the following basic information of the user:
gender; age; grade level; school(s) where the user is attending or has attended;
geographic location; education level of a guardian; occupation of a guardian;
and favorite study subject(s).

36. The system as recited in claim 26, wherein the multilevel arrangement of the evaluation contents is at least partially determined according to a multilevel arrangement of the knowledge points which are evaluated by the evaluation contents, and wherein the multilevel arrangement of the evaluation contents includes one or more of a tree structure, a pyramidal structure, a star structure, a chain structure, a ring structure and a grid structure of the evaluation contents.

37. The system as recited in claim 26, comprising a storage device storing the plurality of evaluation contents and a plurality of relational data containing values of attributes of each evaluation content, the attributes including at least one of “subject matter”, “related knowledge point(s)”, “evaluation type”, “difficulty level”, “comprehensiveness level”, and “grade level”.

38. The system as recited in claim 26, wherein each evaluation content's values of attributes are stored as a multi-field record of a database in which each attribute corresponds to a field of the record.

39. The system as recited in claim 26, wherein the characteristic information of the user includes a historic information of the user, and wherein the determining of the subsequent evaluation content by the determining unit further comprises:
determining from the historical information of the user whether the user has a learning ability satisfying an aptitude condition; and if affirmative,
skipping a next evaluation content relative to the present evaluation content in the multilevel arrangement of the evaluation contents and selecting a further next evaluation content relative to the next evaluation content in the multilevel arrangement to be the subsequent evaluation content.
